(19) United States
(12) Patent Application Publication
(10) Pub. No.: US 2024/0289342 A1
(43) Pub. Date: Aug. 29, 2024

(54) INTERACTIVE NETWORK FOR MULTI-MODAL BIOMARKER DISCOVERY FOR COMPLEX DISEASES

(71) Applicant: International Business Machines Corporation, Armonk, NY (US)

(72) Inventors: Aldo Guzman Saenz, White Plains, NY (US); Aritra Bose, White Plains, NY (US); Daniel Enoch Platt, Putnam Valley, NY (US); Laxmi Parida, Mohegan Lake, NY (US); Niina Haiminen, Tampere (FI)

(21) Appl. No.: 18/115,295

(22) Filed: Feb. 28, 2023

(51) Int. Cl. G06F 16/248; G06F 16/2455

(52) U.S. Cl. CPC G06F 16/248; G06F 16/2455

(57) ABSTRACT

A cumulant-based network analysis visualizer (CuNAviz) includes an interactive dashboard with a user interface and a display that allows a user to query a network of multi-modal biomarkers for phenotypes associated with a complex disease and to visualize answers to the queries as subgraphs. The subgraphs include highlighted nodes and edges where the highlighted nodes represent the multi-modal biomarkers from the network that are associated with the queried phenotypes for the complex disease and the highlighted edges represent the interactions between the multi-modal biomarkers that are associated with the queried phenotypes for the complex disease. The CuNAviz allows a user to identify important multi-modal biomarkers and neighborhoods of multi-modal biomarkers specific to a complex disease.

### STATEMENT REGARDING PRIOR DISCLOSURES BY THE INVENTORS

The following disclosure is submitted under 35 U.S.C. 102(b)(1)(A): Python implementation of CuNA in the Geno4SD framework made available as an open-source tool on Oct. 20, 2022, at: https://github.com/ComputationalGenomics/Geno4SD/.

### TECHNICAL FIELD

The present invention relates generally to biomarker discovery and more specifically, to a computer-implemented interactive system for visualizing multi-modal biomarkers for complex diseases.

### BACKGROUND OF THE INVENTION

In complex diseases, thousands of significant associations across multi-modal biomarkers, such as genes and single nucleotide polymorphisms (SNPs), have been identified; thus, there is a need to process these large numbers of connected data components in order to obtain meaningful data interpretations of functional significance. In complex diseases, such as cardiovascular diseases, neurological diseases, and cancer, which can have many phenotypes associated with many genes and/or SNPs, it is important to understand how the genes and/or SNPs that are associated with the diseases lead to the disease phenotypes. For example, with cardiovascular diseases, there is a need to associate specific genes with heart tissues and/or dietary phenotypes, the latter including BMI, waist-to-hip circumference ratio, Type II Diabetes Mellitus, hypertension, and hyperlipidemia. With a neurological disease, such as Parkinson's Disease, there is a need to identify genes related with motor and non-motor symptoms in order to identify overlapping genes between early vs. late onset symptoms.

### SUMMARY OF THE INVENTION

The present invention addresses this need with an interactive dashboard that allows a user to query a network of multi-modal biomarkers to identify the multi-modal biomarkers that are associated with complex disease phenotypes.

In one embodiment, the present invention relates to a system comprising: a cumulant-based network analysis tool configured to ingest a network of multi-modal biomarkers relating to a complex disease and produce a graphical representation of the network with nodes representing the multi-modal biomarkers and edges representing interactions between the multi-modal biomarkers; and an interactive dashboard comprising a user interface and a display, wherein the user interface is configured for queries relating to one or more phenotypes associated with the complex disease and answers to the queries are visualized on the display as subgraphs of the graphical representation of the network, wherein multi-modal biomarkers of the network that are associated with the one or more queried phenotypes are displayed as highlighted nodes on the subgraphs and interactions of the multi-modal biomarkers that are associated with the one or more queried phenotypes are highlighted as edges on the subgraphs.

In another embodiment, the present invention relates to a computer implemented method comprising: ingesting a network of multi-modal biomarkers relating to a complex disease into a cumulant-based network analysis (CuNA) tool that produces a graphical representation of the network comprising nodes representing multi-modal biomarkers and edges representing interactions between the multi-modal biomarkers, wherein the CuNA tool is associated with an interactive dashboard comprising a user interface for queries relating to one or more phenotypes associated with the complex disease and a display for visualizing answers to the queries as subgraphs of the graphical representation of the network; and entering one or more queries into the interactive user interface and generating subgraphs in response to the one or more queries, wherein multi-modal biomarkers of the network that are associated with the one or more queried phenotypes are displayed as highlighted nodes on the subgraphs and interactions of the multi-modal biomarkers that are associated with the one or more queried phenotypes are highlighted as edges on the subgraphs.

In a further embodiment, the present invention relates to a computer program product for discovery of multi-modal biomarkers for complex diseases comprising: program instructions on one or more computer readable storage media for ingesting a network of multi-modal biomarkers relating to a complex disease and producing a graphical representation of the network as nodes representing the multi-modal biomarkers and edges representing interactions between the multi-modal biomarkers; and program instructions on one or more computer readable storage media for building an interactive dashboard comprising a user interface for queries relating to one or more phenotypes associated with the complex disease and a display for visualizing answers to the queries as subgraphs of the graphical representation of the network, wherein multi-modal biomarkers of the network that are associated with the one or more queried phenotypes are displayed as highlighted nodes on the subgraphs and interactions of the multi-modal biomarkers that are associated with the one or more queried phenotypes are highlighted as edges on the subgraphs.

Additional aspects and/or embodiments of the invention will be provided, without limitation, in the detailed description of the invention that is set forth below.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 shows a network of Parkinson's Disease (PD) phenotypes generated from the cumulant-based network analysis (CuNA) tool described herein.

FIG. 2 shows a network for breast cancer phenotypes generated with the CuNA tool.

FIG. 3 shows a network for COVID-19 symptoms generated with the CuNA tool.

FIGS. 4A-4G shows application of the CuNA visualizer (CuNAviz) to identify multi-modal biomarkers for right-side and left-side PD phenotypes

FIG. 5 shows application of the CuNAviz system to identify multi-modal biomarkers for autonomic and mouth muscle PD motor phenotypes.

FIG. 6 shows application of the CuNAviz system to identify genes associated with PD motor phenotypes.

FIG. 7 is a schematic diagram of a computer environment that may be used to implement the CuNA, CuNAviz system, and CuNAviz subgraphs described herein.

### DETAILED DESCRIPTION OF THE INVENTION

Set forth below is a description of what are currently believed to be preferred aspects and/or embodiments of the claimed invention. Any alternates or modifications in function, purpose, or structure are intended to be covered by the appended claims. As used in this specification and the appended claims, the singular forms “a,” “an,” and “the” include plural referents unless the context clearly dictates otherwise. The terms “comprise,” “comprised,” “comprises,” and/or “comprising,” as used in the specification and appended claims, specify the presence of the expressly recited components, elements, features, and/or steps, but do not preclude the presence or addition of one or more other components, elements, features, and/or steps.

As used herein, the term “complex disease” refers to a disease state with multiple phenotypes. Within the context of the present invention, examples of complex diseases include, without limitation, cardiovascular diseases, neurological diseases, cancer, bacterial diseases, viral diseases, and combinations thereof.

As used herein, the term “phenotype” (and its plural referent) refers to observable characteristics of a disease and includes within its scope, “symptoms,” which are physical conditions of a disease that are experienced by an individual. With some complex diseases, such as for example, PD and COVID-19, the characteristics of the disease are often described with symptoms; thus, within the context of the CuNA multi-modal discovery tool described herein, the symptoms of a such complex disease will comprise the phenotypes that are entered as queries into the CuNA tool. Within the context of the present invention, phenotypes (including symptoms) of a complex disease may also be referred to as a “target phenotypes.”

As used herein, the term “variable phenotype” (and its plural referent) refers to measurable characteristics of a disease and includes multi-modal biomarkers. It is to be understood that within the context of the present invention, a target phenotype comprises the observable characteristics of a complex disease (including symptoms) that are queried in the CuNA tool whereas variable phenotypes are part of the multi-modal discovery network of the CuNA tool.

As used herein, the term “biomarker” refers to a measurable indicator of some biological condition or disease state and the term “multi-modal biomarker” refers to relationship between two or more biomarkers in a disease state. While a biomarker is a measurable indicator of some disease state, a multi-modal biomarker includes features based on two or more measurements relating to a disease state. Within the context of the present invention, multi-modal biomarkers are any measurable healthcare variable. Examples of multi-modal biomarkers include, without limitation, genes, SNPs, messenger RNA (mRNA), microRNA (small, single-stranded, non-coding RNA molecules containing approximately 20 to 25 nucleotides), proteins, metabolites, enzymes, and variable phenotypes. Examples of variable phenotypes that may be used as multi-modal biomarkers include, without limitation, imaging-derived phenotypes (phenotypes obtained from imaging scans, such as MRIs), continuous phenotypes (expression of a trait based upon genetic and non-genetic factors, such as height and weight), and binary phenotypes (measurable physiological traits, e.g., coronary artery disease, glaucoma, a type of cancer, etc., represented by “1” for carriers and “0” for non-carriers).

As used herein, the term “multi-modal neighborhood” refers to the pairwise interactions between two or more multi-modal biomarkers.

As used herein, the terms “cumulant” and “cumulant-based” refer to a statistical method of partitioning random parameters into independent polynomials.

As used herein, the terms “node” and “edge” refer to the fundamental units on which a graph is formed. In graph diagrams, nodes, which represent data and are identified by labeled circles, are connected by edges, which are represented by a line extending from one node to another. A single node may attach to multiple edges. Within the context of the graphical representation of biomarkers described herein, nodes and edges represent multi-modal biomarkers where individual nodes represent individual biomarkers and edges represent the one or more interactions between individual biomarkers.

As used herein, the terms “ingest,” “ingested,” and “ingesting” refer to the delivery of data into a computer system such that the data may be in a position to be processed in response to downstream commands.

As used herein, the term “degree” refers to the number of edges connected to a node. Node degree is represented by the color of the nodes in a network graph.

As used herein, the term “eigenvector centrality” refers to the level of influence of a node within a network. Each node in a network is given a score based upon the number of connections that the node has to other nodes. A node with connections to high-scoring nodes will have a higher score than nodes with connections to an equal number of low scoring nodes. A high eigenvector score means that a node is connected to many nodes with high scores.

As used herein, the term “betweenness centrality” refers to the measure of influence a node has over the flow of information in a network graph. It is used to find nodes that serve as a bridge from one part of a graph to another by calculating the shortest paths between all pairs of nodes in a graph. Each node receives a score based on the number of shortest paths that pass through the nodes where a high score is given to those nodes that more frequently lie on shortest paths between nodes.

As used herein, the term “information centrality” refers to the harmonic mean length of paths ending at a vertex. A harmonic mean is calculated by dividing the number of observations in a series by the reciprocal of each number in the series. With information centrality, the harmonic mean is smaller when a vertex has many short paths connecting it to other vertices.

As used herein, the term “voterank” refers to the ranking of nodes in a graph based upon a voting scheme. With voterank, all nodes vote for each of its in-neighbors and the node with the highest votes is elected iteratively. The voting ability of out-neighbors of elected nodes is decreased in subsequent turns.

Described herein is an interactive visualizer for cumulant-based network analysis (CuNA) of multi-modal biomarkers associated with a complex disease. The CuNA visualizer (CuNAviz) allows a user to interactively query a network of multi-modal biomarkers with questions relating to target phenotypes of a complex disease and receive automated answers in the form of displayed subgraphs with nodes representing the multi-modal biomarkers and edges representing the interactions between the multi-modal biomarkers. Analysis of the nodes and edges allows a user to identify specific multi-modal biomarkers that are responsible for the target phenotypes specific to complex diseases.

Integrated within the CuNAviz is a CuNA tool that finds associations between biomarkers and phenotypes of interest. The CuNAviz, which is the interactive visualizer of the CuNA tool, allows a user to test hypotheses about disease sub-types and to identify multi-modal biomarkers associated with phenotypes of interest. The CuNA tool, which performs community detection on a network, is constructed from multi-modal biomarker interactions and is developed from the following algorithm (Algorithm 1):
Input: Set of k features, Y=y₁, y₂, . . . , yₖ, containing candidate biomarkers of diseases;
Output: Communities, M=m₁, m₂, . . . , mₚ, of interactions between the genes, SNPs, and phenotypes.
   1. Compute moments to identify higher-order interactions between Y.
   2. Perform permutation tests and obtain F, statistically significant subset of features.
   3. Construct network and detect communities M=NetCoDe(F).
   4. Annotate M to discover biological pathways underlying candidate biomarkers.

The NetCoDe (network formation and community detection) is constructed according to the following algorithm (Algorithm 2):
Input: F=f₁, f₂, . . . , fₗ, where fᵢ is a group of k features denoted by fᵢ=fᵢ₁, fᵢ₂, . . . fᵢₖ.
Output: Communities, M=m₁, m₂, . . . mₚ, of interactions between the biomarkers.
   1. FOR all l groups of features:
   2. FOR all (i, j) pair of (₂^{k}) features:
   3. Compute Nᵢⱼ=nᵢⱼ, n*ⱼ, nᵢₓ, n*.*
   4. Obtain p-value p_{i,j} Fisher's exact test on N_{i,j}.
   5. IF p_{i,j}<0.05
   6. E [U]eᵢⱼ
   7. V U Vᵢ, Vⱼ
   8. END IF
   9. END FOR
   10. END FOR
   11. Build a network, G=(V, E) where vertices (V) are features fᵢ and fⱼ and the edge (E) between them have weights Cᵢⱼ.
   12. Perform community detection using any method of choice and obtain M communities.

As provided in Algorithm 2, the CuNA builds the networks between the features where the edge weights between the features reflect the number or times those features are grouped together in all the subsets of features in the cumulant computations. The interaction network can be dense with a total of (₂^{k}) edges with k features. In one embodiment, only a small percentage of edges are allowed until all k features are observed for ease of visualization and analysis. In another embodiment, the CuNA tool computes cumulant groups and constructs networks with only statistically significant connections between any two pair of features i and j. The CuNA tool computes Nᵢⱼ as a tuple of (i) the number of cumulant groups containing both i and j denoted as nᵢⱼ; (ii) the number of groups consisting only i: nᵢ*; (iii) the number of groups consisting only j: n*j; and (iv) the number of cumulant groups without either of i or j. The foregoing tuple allows for the computation of a Fisher's exact test (with pairs of features having p<0.05), the obtaining of significance parameters for each pair i and j, and a determination on whether the edge between any pair i and j in a network is random.

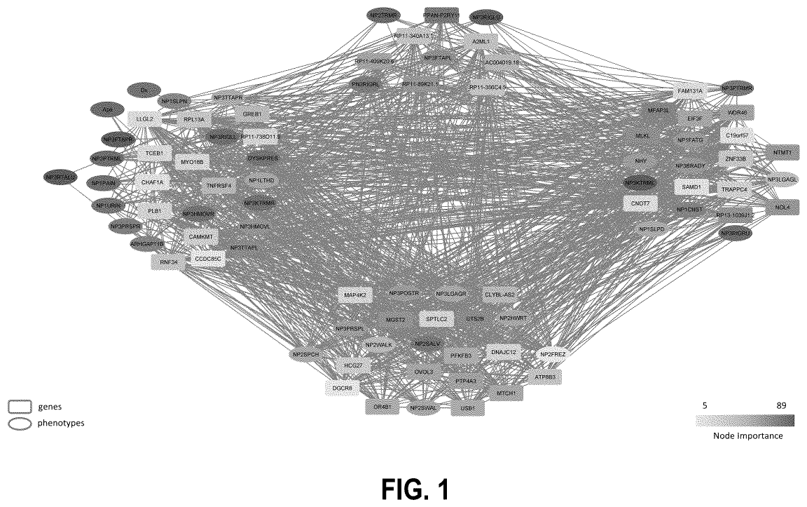

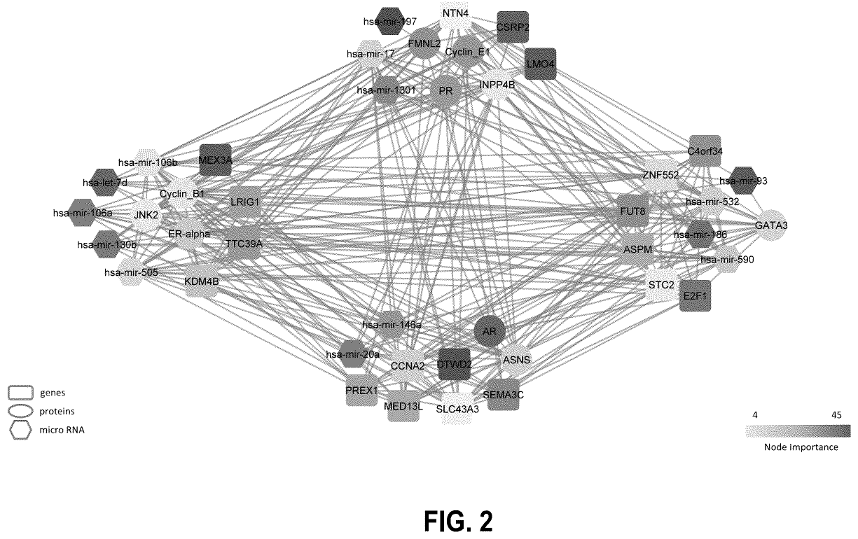

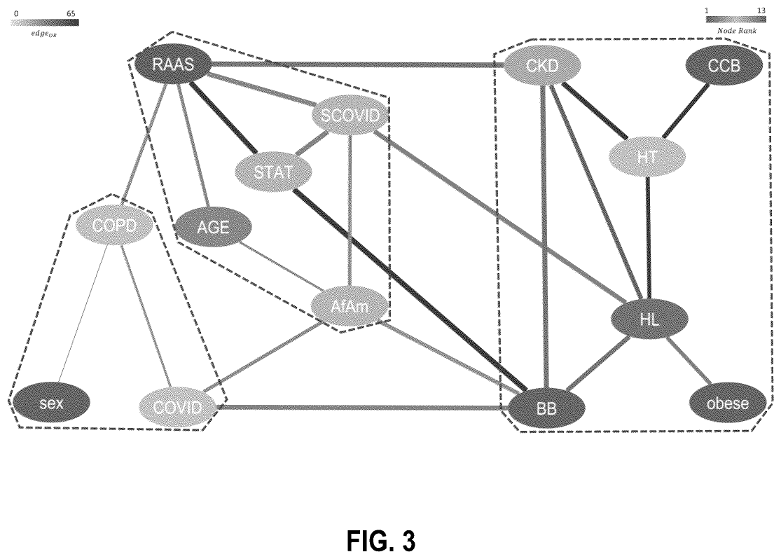

The CuNA tool may be used to ingest electronic health records (EHRs) for any disease (including genes and genetic variants) as features and computes higher-order associations between the features to find subsets of features influencing groups of individuals with similar underlying biological pathways. The ingestion of EHRs into the CuNA tool generates a network that facilitates community detection and analysis of latent interactions between biomarkers (such as genes and/or SNPs) and the phenotypes associated with a disease state. Example 1 describes the generation of a multi-modal biomarker network for Parkinson's Disease (PD) phenotypes and FIG. 1 shows the three communities, 134 nodes, and 1780 edges of the PD network of Example 1. In FIG. 1, the nodes at the top of the network do not have their own community, but instead are assigned the communities on the left, right, and bottom of the network graph. It is to be understood that the number of communities in any network graph may be different depending on how the community detection algorithm is programmed to assign the community parameters. In other words, a single network may be represented by several different communities by way of adjusting the parameters of the community detection algorithm. Example 2 describes the generation of a multi-modal biomarker network for breast cancer phenotypes and FIG. 2 shows the four communities, nodes, and edges associated with the breast cancer network of Example 2. Example 3 describes the generation of a multi-modal biomarker network for COVID-19 symptoms and FIG. 3 shows the three communities, nodes, and edges of the COVID-19 network of Example 3.

In one embodiment, the CuNAviz describe herein is configured to ingest a network multi-modal biomarkers relating to a complex disease and generating a graphical representation of the network comprising nodes representing the multi-modal biomarkers and edges representing interactions between the multi-modal biomarkers. The collection of multi-modal biomarkers may be ingested into the CuNAviz via the CuNA tool described herein.

In a further embodiment, the CuNAviz comprises an interactive dashboard with a user interface and a display. The interactive dashboard accepts user queries relating to one or more target phenotypes associated with the complex disease and answer to the queries are visualized on the display as subgraphs of the graphical representation of the network, wherein multi-modal biomarkers of the network that are associated with the one or more queried phenotypes are displayed as highlighted nodes on the subgraphs and interactions of the multi-modal biomarkers that are associated with the one or more queried phenotypes are highlighted as edges on the subgraphs. Subgraphs of interest may be obtained by identifying nodes associated with phenotypes of disease states and selecting the smallest (by edge weight and number of nodes) subgraph containing those nodes.

In another embodiment, a neighborhood of multi-modal biomarkers is established for the complex disease by measuring the shortest edge distance between any node pair within a subgraph.

In a further embodiment, a node importance score is calculated by taking an aggregate of various different centrality measures relating to the edges associated with the nodes. Examples of such centrality measures include, without limitation, node degree, eigenvector centrality, betweenness centrality, information centrality, voterank, and combinations thereof.

In another embodiment, an overlapping node is identified as a single node highlighted by two or more queries.

In a further embodiment, an overlapping node spanning two or more subgraphs indicates a significant multi-modal biomarker for the complex disease.

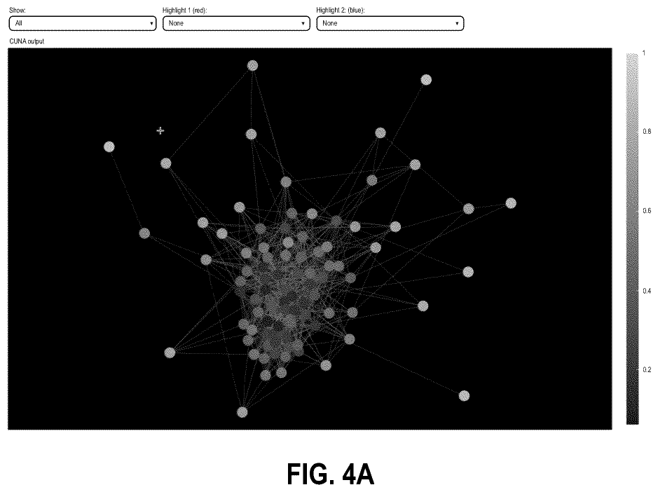

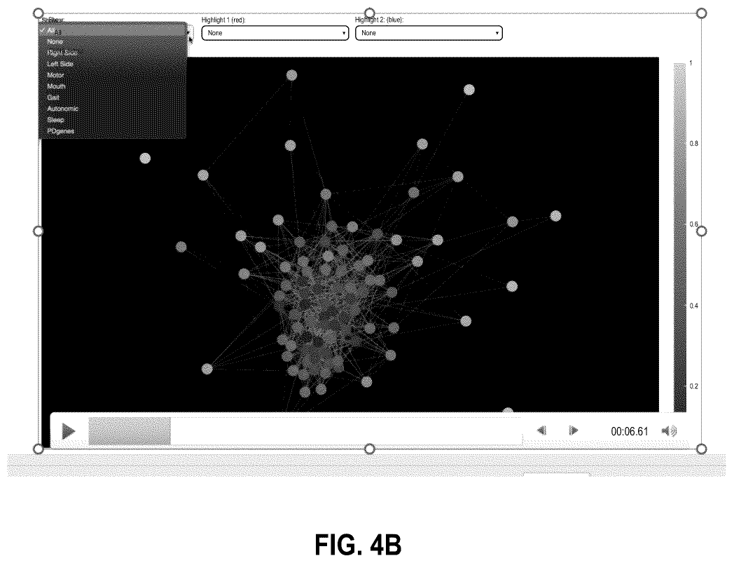

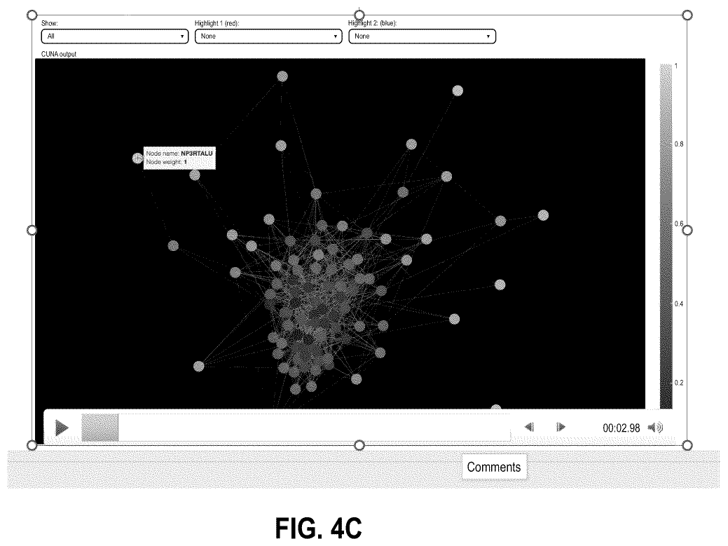

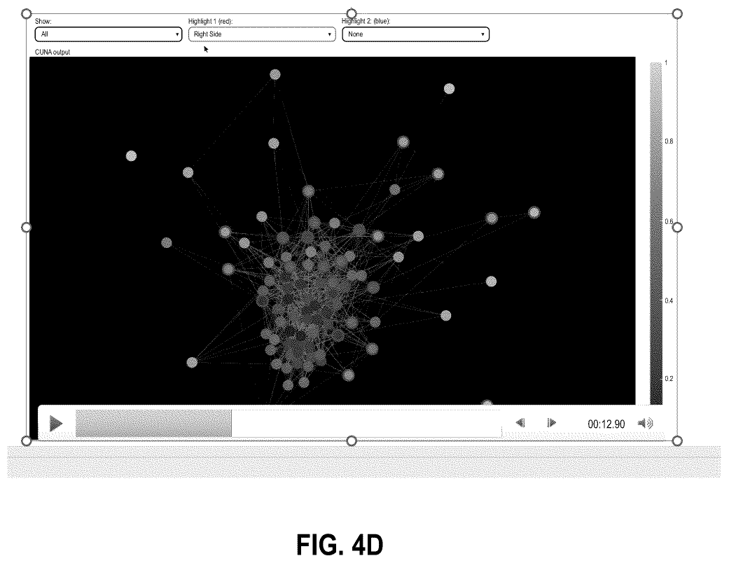

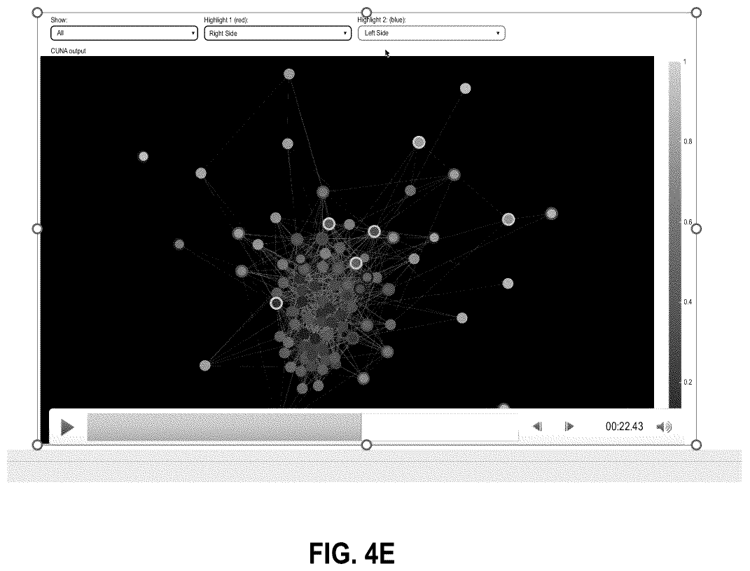

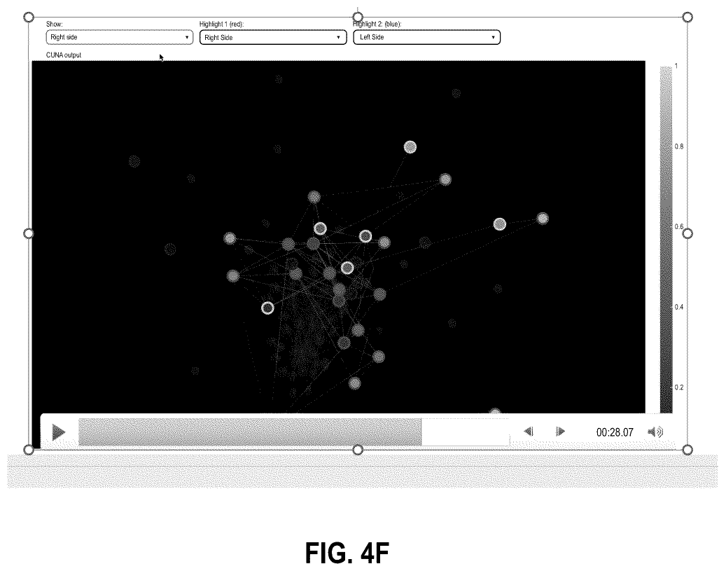

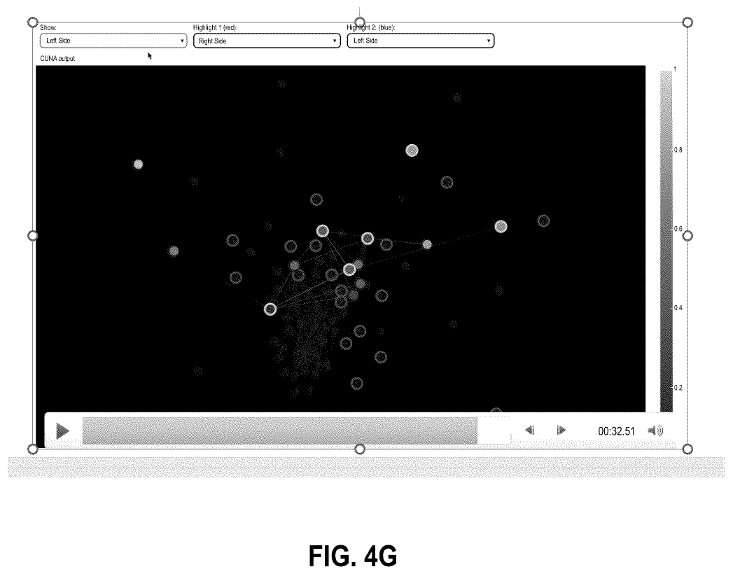

FIGS. 4A-4H shows application of the CuNAviz for detection of PD biomarkers and/or genes. FIG. 4A shows a multi-modal biomarker network for PD ingested into the CuNAviz prior to a user query. FIG. 4B shows the menu items for the first of three selection boxes for the interactive dashboard of the CuNAviz; these same menu items are available for the remaining two selection boxes (i.e., the Highlight 1 (red) and Highlight 2 (blue) selection boxes). The menu items allow a user to query the CuNAviz with different hypotheses about disease phenotypes, such as late versus early onset of symptoms in the case of PD or to discover biomarkers related with lateral asymmetry of symptoms between the left and right side of the body in PD patients.

In another embodiment, the CuNAviz system is able to identify node significance and overlap by way of colors. With reference to the CuNAviz interactive dashboard shown in FIGS. 4A-4H, the CuNAviz allows a user to select different subgraphs corresponding to any of the queries shown in the menu items and further allows a user to select two different subgraphs corresponding to two queries about right-side and left-side PD symptoms where the right-side nodes are highlighted in red, the left-side nodes are highlighted in blue, and overlapping nodes are highlighted in pink. It is to be understood that the red, blue, and pink colors are exemplary and that any other combination of colors may be used for highlighting CuNAviz subgraphs. An overlapping node that spans more than one subgraph may be considered to be a significant node; thus, indicating that the biomarker associated with the overlapping node is an important biomarker for the queried disease state.

FIG. 4C shows that when a user hovers a computer curser over a node of the CuNAviz, the node name and weight is displayed. The identified node, NP3RTALU, has a node weight of 1 according to the node weight widget shown to the right of the CuNAviz subgraph. The node name, NP3RTALU, represents the PD phenotype of “rest tremor of left upper extremity.” As the more important nodes in the subgraphs of FIGS. 4A-4H have darker colors and the less important nodes have lighter colors, the node weight 1 for NP3RTALU indicates that this phenotype is not an important biomarker for PD. Hovering over an edge will similarly display an edge weight (not shown). The identification of nodes and edges facilitates the parsing of a multi-modal biomarker network and allows a user to understand how a particular biomarker is associated with a set of disease symptoms or to relate disease symptoms with a genetic target of interest.

FIG. 4D shows a collection of all CuNAviz subgraphs with right-side PD symptoms highlighted in red and FIG. 4E shows the same collection of all CuNAviz subgraphs with right-side PD symptoms highlighted in red, left-side PD symptoms highlighted in blue, and overlapping left and right PD symptoms highlighted in pink. As noted above, the importance of any node and/or edge within the selected subgraphs can be identified by hovering over the node or edge to obtain a node weight or edge weight, respectively. FIG. 4F refines the collection of CuNAviz subgraphs to just the CuNAviz subgraphs relating to right-side PD symptoms (left box selection of “right-side”) while maintaining the right-side PD symptom (red) and left-side PD symptom (blue) highlights. FIG. 4G refines the collection of CuNAviz subgraphs to just the CuNAviz subgraphs related to left-side PD symptoms (left box selection of “left-side”). In FIG. 4F, the CuNAviz no longer shows connections (i.e., edges) between the highlighted left side PD symptom nodes while maintaining the right-side connections between the right-side PD symptom nodes. Similarly, in FIG. 4G, the CuNAviz no longer shows connections between the highlighted right-side PD symptom nodes while maintaining the left side connections between the left side PD symptom nodes.

By limiting the CuNAviz subgraphs to the right and left subgraphs as provided in FIGS. 4F and 4G, respectively, a user of the CuNAviz may reduce the size of the subgraphs thus making it is easier to identify important nodes (i.e., multi-modal biomarkers) for a phenotype of interest by making the edges associated with any one node more visible. As noted above, node importance may be determined based upon an aggregate of centrality measures selected from the group consisting of node degree, eigenvector centrality, betweenness centrality, information centrality, voterank, and combinations thereof. With a heavily populated subgraph, such as the subgraphs in FIGS. 4A-4E, the number of edges associated with an important node located in the center of the subgraph (i.e., a node having a dark color according to the side widget) cannot be readily calculated. By contrast, in FIGS. 4F and 4G, the number of edges associated with the highlighted nodes are measurable. Similarly, the subgraphs in FIGS. 4F and 4G allow for the identification of a neighborhood of multi-modal biomarkers by measuring the shortest edge distance between any node pair; measurements that would be difficult to achieve in the more crowded subgraphs of FIGS. 4A-4E.

The subgraphs of FIGS. 4F and 4G also allow a user of the CuNAviz to more readily visualize the connections of the overlapping (pink) nodes. For example, in FIG. 4F, which shows right-side PD symptom subgraphs, the right/left overlapping pink nodes only show connections for the right-side PD symptom (red) nodes. Similarly, in FIG. 4G, which shows left side PD symptom subgraphs, the right/left overlapping pink nodes only show connections for the left-side PD symptom (blue) nodes. In this way, the individual connections of the overlapping nodes may be analyzed to identify which important left-side only or right-side only nodes (i.e., multi-modal biomarkers) interact with the overlapping nodes.

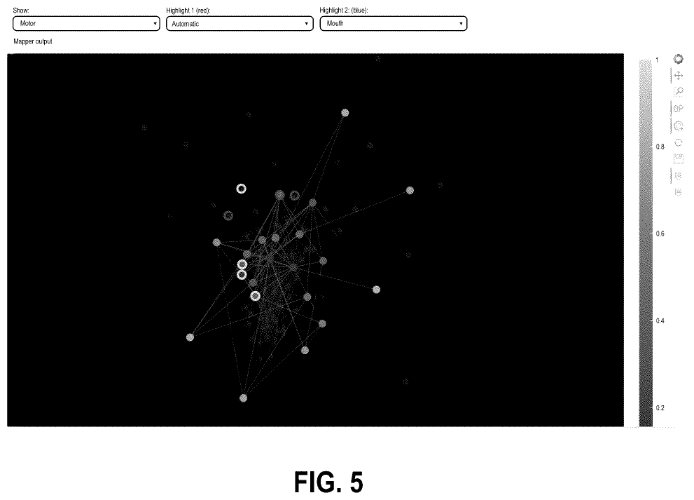

FIG. 5 shows CuNAviz subgraphs related to PD motor symptoms with autonomic symptoms highlighted in red and mouth muscle symptoms highlighted in blue. The overlapping pink nodes highlight the motor symptoms related to mouth muscles. The lack of blue highlights in this figure reveal that all of the mouth muscle nodes are overlapped with the autonomic nodes, which indicates that all of the mouth muscle symptoms represented in the CuNAviz subgraphs of FIG. 5 are overlapping with the autonomic symptoms. While mouth muscle symptoms are considered to be a subset of motor symptoms, the lack of motor subgraph connections for the uppermost pink node indicates that the autonomic/mouth muscle PD symptoms (e.g., breath and epiglottis control) associated with this uppermost pink node are not directly connected to PD motor symptoms.

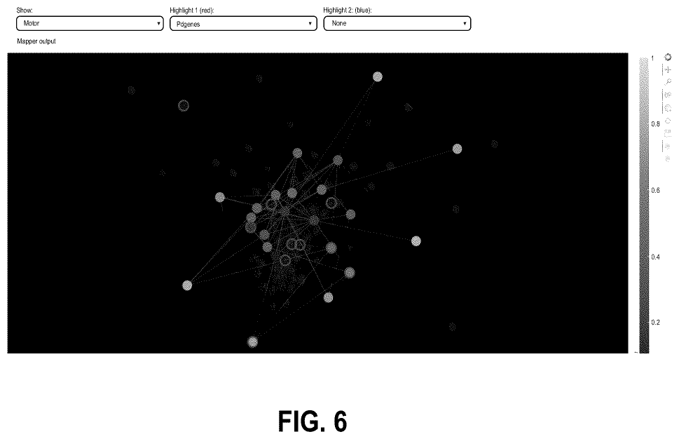

FIG. 6 shows the same CuNAviz subgraphs related to PD motor symptoms as shown in FIG. 5, but with just PD genes highlighted in red. The red highlights in this motor subgraph highlights the importance neighborhood of the queried motor symptoms. More specifically, the red highlights show that most of the PD genes are in the neighborhood spanned by the motor symptom nodes indicating strong associations between PD genes and the phenotypes associated with PD motor symptoms.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

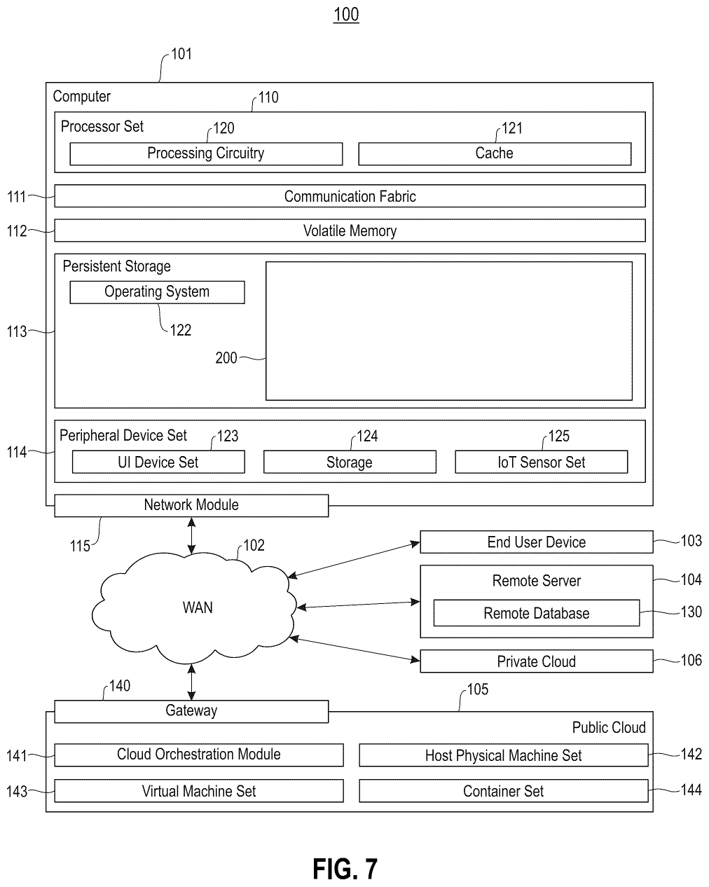

The following discussion refers to FIG. 7. Computing environment 100 contains an example of an environment for the execution of at least some of the computer code involved in performing the inventive methods, such as codes for generating a multi-modal biomarker network and building a CuNAviz system for parsing multi-modal biomarkers specific for complex diseases 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 7. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

The descriptions of the various aspects and/or embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the aspects and/or embodiments, the practical application or technical improvement over technologies found in the marketplace, or to enable others of ordinary skill in the art to understand the aspects and/or embodiments disclosed herein.

### Experimental

The following examples are set forth to provide those of ordinary skill in the art with a complete disclosure of how to make and use the aspects and embodiments of the invention as set forth herein. While efforts have been made to ensure accuracy with respect to variables, experimental error and deviations should be considered.

### Example 1

### Building a Multi-Modal Biomarker Network for Parkinson's Disease Phenotypes

A multi-modal biomarker network for PD phenotypes was built using the CuNA tool described herein and expression quantitative trait loci (eQTLs) from 741 individuals, which included 502 PD cases and 239 healthy controls (HC), with approximately 5.7 million genotype markers and 34,386 genes with their expression information. 48 cis-eQTL and 154,270 trans-eQTLs were obtained after multiple hypothesis corrections from 239 statistically significant cis-eQTLs. Since trans-eQTLs are more prone to be affected by system errors between genomic regions than cis-eQTLs, only cis-eGenes were considered.

The CuNA tool was executed on 96 pre-selected cis-eQTLs and cis-eGenes along with 38 motor and non-motor phenotypes along with demographic information obtained from the Parkinson's Progression Marker Initiative (PPMI), which included the MDS-UPDRS (movement disorder society-sponsored revision of the unified Parkinson's Disease Rating Scale) features, Hoehn and Yahr (HY) scale, age, sex, etc. Cumulants of the higher order interactions between all of the features were computed. Starting from 2,559,196 sets of features with similar patterns, 761 significant sets of redescription groups (features defining a pattern) groups were obtained by filtration by applying different thresholds for p=[10-12, 0.01]. From the 761 redescription groups, a network for PD with dense interactions was constructed among all of the associated features resulting in 1780 edges for 134 features.

Three communities were obtained from the full network: (1) a community containing most of the motor symptoms and their biomarkers relating to the left-side and right-side of the body, such as finger and tow tapping, kinetic tremor, rest tremor amplitude, etc.; (2) a community containing symptoms and their related biomarkers relating to gait, freezing, bradykinesia, dyskinesia, posture, etc.; and (3) a community containing non-motor symptoms, such as swallowing, and their biomarkers.

From the network, the most important nodes were obtained by measuring across a host of centrality measures, including degree, eigenvector centrality, betweenness centrality, information centrality, voterank. The CuNA tool ranks each node for all of the measures by order of importance where the node with the lower rank is the most important node. FIG. 1 shows the multi-modal biomarker network for PD with the 134 features as color-coded nodes of phenotypes (oval nodes) and genes (rectangular nodes) ranging from an importance value of 5 (light green nodes) to an importance value of 90 (dark teal nodes). The five most important nodes in the network, each of which is represented with a light green hue and all of which are associated with PD directly or indirectly, are the phenotype NP2FREZ (freezing symptoms) and the genes CNOT7 (CCR4-NOT transcription complex subunit 7), DGCR8 (DiGeorge Syndrome Critical Region Gene 8), CCDC85C (coiled domain containing 85C), and SAMD1 (sterile alpha motif domain containing 1).

### Example 2

### Building a Multi-Modal Biomarker Network for Breast Cancer Phenotypes

The CuNA tool was used to build a multi-modal biomarker network for breast cancer phenotypes, which included 150 samples trained with the following biomarkers: mRNA (n=200), microRNA (n=184), and proteins (n=142). The 150 samples were classified into the following three subgroups: 75 Luminal A, 30 Her2, and 45 Basal. FIG. 2 shows the four communities of the resultant network with color-coded nodes of genes (square nodes), proteins (round nodes), and microRNA (hexagon nodes) ranging from an importance value of 4 (light yellow) to 45 (dark blue). The most important nodes in the network, each of which is represented with light yellow and light green hues and all of which are directly related with breast cancer incidence, are the genes NTN4 (netrin 4 protein coding gene), SLC43A3 (solute carrier family 32-member 3 protein coding gene), STC2 (stanniocalcin 2 protein coding gene), and the proteins JNK2 (c-jun N-terminus kinase 2) and INPP4B (inositol polyphosphate 4-phosphtase type II).

### Example 3

### Building a Multi-Modal Biomarker Network for Covid-19 Symptoms

The CuNA tool was used to build a multi-modal biomarker network for COVID-19 symptoms in order to understand how clinical biomarkers and other metabolic syndromes impact COVID-19 severity. To test the significance of the network, each interaction was evaluated over a range of p=[10-12, 0.01]. Odds ratio from pairwise logistic regressions between the nodes were also computed and used as an additional weight in the network to prune and select robust edges for statistical significance and limiting spurious interactions between the EHR variables. FIG. 3 shows the three communities (marked by dashed lines) in the COVID-19 network, which include (1) RAAS (renin-angiotensin-aldosterone system), SCOVID (severe COVID-19), AfAm (African Americans), STAT (statins), and age; (2) BB (beta blockers), CKD (chronic kidney disease), obese (obesity), HL (hyperlipidemia), HT (hypertension), and CCB (chronic calcium channel blocker); and (3) COVID (COVID-19 susceptibility), COPD (chronic obstructive pulmonary disease), and sex. In this network, (i) nodes are colored by their relative rank where gradients of brown to green correspond with higher to lower rank; (ii) edges are colored by their respective pairwise odds ratios (ORs) where gradients of light to dark corresponds with low to high ORs; and (iii) edge width indicates the strength of the connections between them. The following pairs show the highest ORs: {HT, CCB}, {HT, CKD}, {RAAS, STAT}, and {BB, STAT}. The most important nodes in the network are RAAS, BB, HL, AfAm, and SCOVID.

We claim:

1. A system comprising:
a cumulant-based network analysis tool configured to ingest a network of multi-modal biomarkers relating to a complex disease and produce a graphical representation of the network with nodes representing the multi-modal biomarkers and edges representing interactions between the multi-modal biomarkers; and
an interactive dashboard comprising a user interface and a display, wherein the user interface is configured for queries relating to one or more phenotypes associated with the complex disease and answers to the queries are visualized on the display as subgraphs of the graphical representation of the network, wherein multi-modal biomarkers of the network that are associated with the one or more queried phenotypes are displayed as highlighted nodes on the subgraphs and interactions of the multi-modal biomarkers that are associated with the one or more queried phenotypes are highlighted as edges on the subgraphs.

2. The system of claim 1, wherein a neighborhood of multi-modal biomarkers is established for the complex disease by measuring the shortest edge distance between any node pair within a subgraph.

3. The system of claim 1, wherein node importance is determined based upon an aggregate of centrality measures selected from the group consisting of degree, eigenvector centrality, betweenness centrality, information centrality, voterank, and combinations thereof.

4. The system of claim 1, wherein an overlapping node is a single node highlighted by two or more queries.

5. The system of claim 4, wherein an overlapping node spanning two or more subgraphs indicates a significant multi-modal biomarker for the complex disease.

6. The system of claim 1, wherein the multi-modal biomarkers are selected from the group consisting of genes, SNPs, mRNA, microRNA, proteins, metabolites, enzymes, imaging-derived phenotypes, continuous phenotypes, binary phenotypes, and combinations thereof.

7. The system of claim 1, wherein the complex disease is selected from the group consisting of cardiovascular diseases, neurological diseases, cancer, bacterial diseases, and viral diseases.

8. A computer implemented method comprising:
ingesting a network of multi-modal biomarkers relating to a complex disease into a cumulant-based network analysis (CuNA) tool that produces a graphical representation of the network comprising nodes representing multi-modal biomarkers and edges representing interactions between the multi-modal biomarkers, wherein the CuNA tool is associated with an interactive dashboard comprising a user interface for queries relating to one or more phenotypes associated with the complex disease and a display for visualizing answers to the queries as subgraphs of the graphical representation of the network; and
entering one or more queries into the interactive user interface and generating subgraphs in response to the one or more queries, wherein multi-modal biomarkers of the network that are associated with the one or more queried phenotypes are displayed as highlighted nodes on the subgraphs and interactions of the multi-modal biomarkers that are associated with the one or more queried phenotypes are highlighted as edges on the subgraphs.

9. The computer implemented method of claim 8, wherein a neighborhood of multi-modal biomarkers for the complex disease is established by measuring the shortest edge distance between any node pair within a subgraph.

10. The computer implemented method of claim 8, wherein a node importance score is calculated based upon an aggregate of centrality measures selected from the group consisting of node degree, eigenvector centrality, betweenness centrality, information centrality, voterank, and combinations thereof.

11. The computer implemented method of claim 8, wherein an overlapping node is a single node that is highlighted by two or more queries.

12. The computer implemented method of claim 11, wherein an overlapping node spanning two or more subgraphs indicates a significant multi-modal biomarker for the complex disease.

13. The computer implemented method of claim 8, wherein the multi-modal biomarkers are selected from the group consisting of genes, SNPs, mRNA, microRNA, proteins, metabolites, enzymes, imaging-derived phenotypes, continuous phenotypes, binary phenotypes, and combinations thereof.

14. The computer implemented method of claim 8, wherein the complex disease is selected from the group consisting of cardiovascular diseases, neurological diseases, cancer, bacterial diseases, and viral diseases.

15. A computer program product for discovery of multi-modal biomarkers for complex diseases comprising:
program instructions on one or more computer readable storage media for ingesting a network of multi-modal biomarkers relating to a complex disease and producing a graphical representation of the network as nodes representing the multi-modal biomarkers and edges representing interactions between the multi-modal biomarkers; and
program instructions on one or more computer readable storage media for building an interactive dashboard comprising a user interface for queries relating to one or more phenotypes associated with the complex disease and a display for visualizing answers to the queries as subgraphs of the graphical representation of the network, wherein multi-modal biomarkers of the network that are associated with the one or more queried phenotypes are displayed as highlighted nodes on the subgraphs and interactions of the multi-modal biomarkers that are associated with the one or more queried phenotypes are highlighted as edges on the subgraphs.

16. The computer program product of claim 15, further comprising program instructions for measuring the shortest edge distance between any node pair within a subgraph in order to identify a neighborhood of multi-modal biomarkers for the one or more queried phenotypes.

17. The computer program product of claim 15, further comprising program instructions for calculating node importance based upon an aggregate of centrality measures selected from the group consisting of node degree, eigenvector centrality, betweenness centrality, information centrality, voterank, and combinations thereof.

18. The computer program product of claim 15, further comprising program instructions for highlighting when a single node is included in answer to two or more queries.

19. The computer program product of claim 15, wherein an overlapping node spanning two or more subgraphs indicates a significant multi-modal biomarker for the complex disease.

20. The computer program product of claim 15, wherein the multi-modal biomarkers are selected from the group consisting of genes, SNPs, mRNA, microRNA, proteins, metabolites, enzymes, imaging-derived phenotypes, continuous phenotypes, binary phenotypes, and combinations thereof.
